(19) United States
(12) Patent Application Publication
(10) Pub. No.: US 2018/0131864 A1
(43) Pub. Date: May 10, 2018

(54) IMAGE PARAMETER-BASED SPATIAL POSITIONING

(71) Applicant: International Business Machines Corporation, Armonk, NY (US)

(72) Inventor: Jeffrey E. Bisti, New Paltz, NY (US)

(21) Appl. No.: 15/343,556

(22) Filed: Nov. 4, 2016

(51) Int. Cl. H04N 5/232; G06T 7/00; H04N 7/18; G05D 1/10; B64C 39/02

(52) U.S. Cl. CPC H04N 5/23216; G06T 7/0022; H04N 7/188; H04N 7/181; B64C 2201/123; G05D 1/10; B64C 39/024; G05D 2201/02; H04N 5/23206

(57) ABSTRACT

In an approach to spatial positioning using image parameters, a computer processor identifies one or more image parameters for an image subject. The processor identifies a first image of the image subject and determines whether the first image meets the one or more image parameters for the image subject. If the first image does not meet the one or more image parameters for the image subject, the processor calculates positional instructions based on the one or more image parameters for the image subject and the identified first image, where the calculated positional instructions include positioning instructions for one or more imaging devices.

### BACKGROUND OF THE INVENTION

The present invention relates generally to the field of imaging, and more particularly to applying image parameters to spatial positioning in unmanned vehicle photography.

Imaging is the representation of an object's form. Often imaging deals with capturing a visual representation of an object to save the image permanently or to temporarily use the image for various applications. Imaging is used in various applications ranging from photography to spatial positioning. Using various image parameters and sensors associated with the image parameters, an imaging device can capture a physical representation, a speed, and a location of an object.

Unmanned vehicle photography is an area of photography that deals with using unmanned vehicles in place of human operators to capture pictures and videos. Unmanned vehicles used in photography, such as aerial and ground-based drones, rely on the versatility and maneuverability associated with particular form factors and movement options available in vehicles that are controlled remotely or function autonomously.

### SUMMARY

Embodiments of the present invention disclose a method, a computer program product, and a system for spatial positioning using image parameters. The method includes one or more computer processors identifying one or more image parameters for an image subject. The one or more computer processors identify a first image of the image subject. The one or more computer processors determine whether the first image meets the one or more image parameters for the image subject. Responsive to determining that the first image does not meet the one or more image parameters for the image subject, the one or more computer processors calculate one or more positional instructions based on the one or more image parameters for the image subject and the identified first image, wherein the calculated one or more positional instructions include positioning instructions for one or more imaging devices.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of an image parameter-based positioning program, on a computer within the distributed data processing environment of FIG. 1, for positioning an unmanned imaging device in a three-dimensional space, in accordance with an embodiment of the present invention;

FIG. 3A and FIG. 3B depict a scenario in which an image parameter-based positioning program repositions an unmanned imaging device to satisfy image parameters; and

FIG. 4 depicts a block diagram of components of the computer executing the image parameter-based navigation program within the distributed data processing environment of FIG. 1, in accordance with an embodiment of the present invention.

### DETAILED DESCRIPTION

Present-day unmanned vehicle based imaging requires partial or complete control by a skilled human operator. As such, the use of unmanned vehicles in imaging can benefit from the application of autonomous spatial navigation based on the image parameters set for the picture, video, or lighting. Applying autonomous image parameter-based spatial positioning to unmanned imaging vehicles can result in a significant improvement in the capabilities of unmanned imaging vehicles such as higher efficiency, increased safety, and improved imaging techniques. For example, spatial positioning using one or more image parameters, such as angle of tile, focal length, and image boundaries, allows unmanned imaging vehicles to autonomously find the ideal position for a photograph without human intervention which may reduce the necessity of expensive equipment rentals, costs associated with hired professionals, and safety risks to human operators. Embodiments of the present invention recognize that unmanned vehicle-based imaging may be improved by removing human control from the spatial position of unmanned vehicles by utilizing image parameters to enable the autonomous spatial positioning of unmanned imaging vehicles. Implementation of embodiments of the invention may take a variety of forms, and exemplary implementation details are discussed subsequently with reference to the figures.

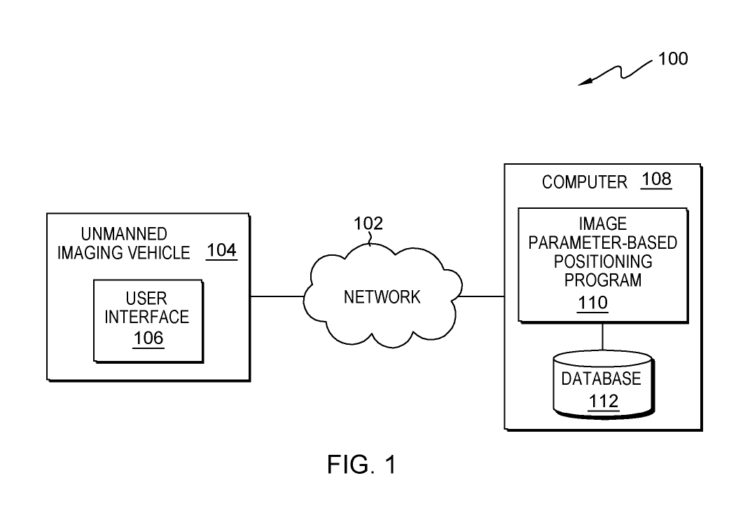

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes unmanned imaging vehicle 104 and computer 108 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between unmanned imaging vehicle 104 and computer 108, and other computing devices (not shown) within distributed data processing environment 100.

Unmanned imaging vehicle 104 can be an aerial imaging vehicle, a ground-based imaging vehicle, or any electronic imaging device capable of using image parameters to determine an optimal position for producing a desired image in a three-dimensional space. In various embodiments, unmanned imaging vehicle 104 may be capable of communication with various components and devices within distributed data processing environment 100, via network 102. In some embodiments, unmanned imaging vehicle 104 may not be capable of communication with various components and devices and function independently of other components and devices within distributed data processing environment 100. In general, unmanned imaging vehicle 104 represents any programmable electronic imaging device capable of receiving image parameters, using the image parameters to occupy an optimal position in a three-dimensional space, and executing machine readable instructions. For example, unmanned imaging vehicle 104 may be an aerial imaging vehicle, a ground-based imaging vehicle, or an image lighting vehicle capable of imaging a designated subject. In the depicted embodiment, unmanned imaging vehicle 104 includes an instance of user interface 106. In an alternative embodiment, unmanned imaging vehicle 104 may not include an instance of user interface 106. In some embodiments, one or more unmanned imaging vehicles 104 may contain one or more sensors allowing the one or more unmanned imaging vehicles 104 to sense the environment.

User interface 106 provides an interface to image parameter-based positioning program 110 on computer 108 for a user of unmanned imaging vehicle 104. In one embodiment, user interface 106 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 may also be mobile application software that provides an interface between a user of unmanned imaging vehicle 104 and computer 108. Mobile application software, or an “app,” is a computer program designed to run on smart phones, tablet computers and other mobile devices. User interface 106 enables the user of unmanned imaging vehicle 104 to register with and configure image parameter-based positioning program 110 to adjust the image parameters, such as the aperture, shutter speed, ISO, focal length, image boundaries, and negative space surrounding image boundaries, by the user of unmanned imaging vehicle 104.

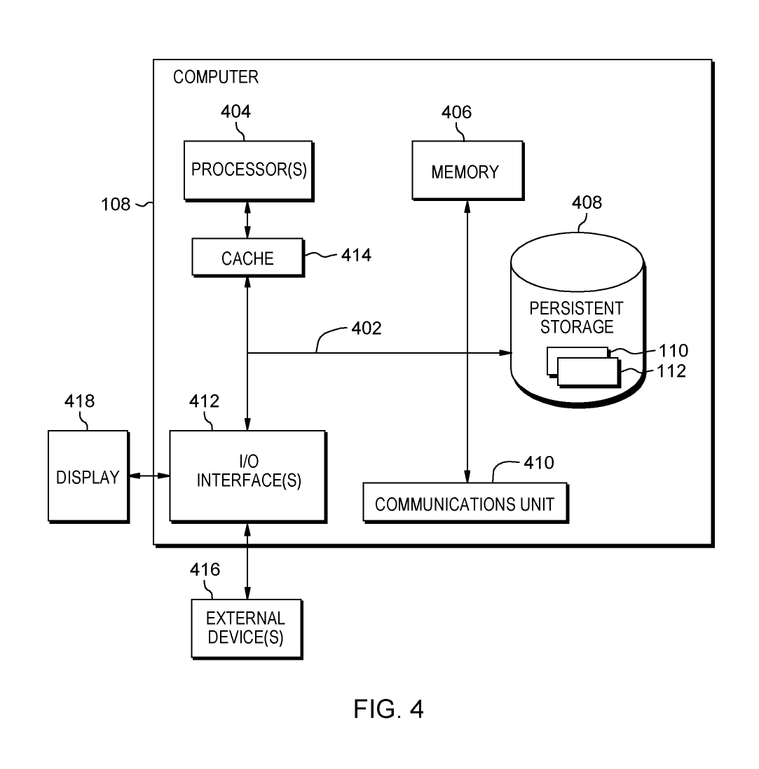

Computer 108 can be a standalone computing device, a management server, a web server, a mobile computing device, or any other electronic device or computing system capable of receiving, sending, and processing data. In other embodiments, computer 108 can represent a server computing system utilizing multiple computers as a server system, such as in a cloud computing environment. In another embodiment, computer 108 can be a laptop computer, a tablet computer, a netbook computer, a personal computer (PC), a desktop computer, a personal digital assistant (PDA), a smart phone, or any other programmable electronic device capable of communicating with unmanned imaging vehicle 104 and other computing devices (not shown) within distributed data processing environment 100 via network 102. For example, computer 108 may be a smart phone that is capable of remotely controlling and sending registration and configuration data to unmanned imaging vehicle 104. In another embodiment, computer 108 represents a computing system utilizing clustered computers and components (e.g., database server computers, application server computers, etc.) that act as a single pool of seamless resources when accessed within distributed data processing environment 100. Computer 108 includes image parameter-based positioning program 110 and database 112. Computer 108 may contain an instance of user interface 106 and image parameter-based positioning program 110 and enable a user to communicate the aforementioned information to unmanned imaging vehicle 104, such as registration and configuration data. Computer 108 may include internal and external hardware components, as depicted and described in further detail with respect to FIG. 4.

Image parameter-based positioning program 110 executes a series of steps to position an unmanned imaging device in a three-dimensional space using image parameters. In some embodiments, image parameter-based positioning program 110 may send image parameters and adjust parameters based on received images and sensor data. For example, image parameter-based positioning program 110 receives image parameters associated with a desired image. Image parameter-based positioning program 110 subsequently sends the image parameters to unmanned imaging vehicle 104. Image parameter-based positioning program 110 then receives a first image from unmanned imaging vehicle 104. Based on the first image, image parameter-based positioning program 110 sends positional adjustment instructions meeting the image parameters to unmanned imaging vehicle 104. Image parameter-based positioning program 110 receives a subsequent image from unmanned imaging vehicle 104. Image parameter-based positioning program 110 then determines whether the subsequent image meets the image parameters. If the image meets the image parameters, then image parameter-based positioning program 110 performs an action, such as sending an instruction to unmanned imaging vehicle 104 to take a photo.

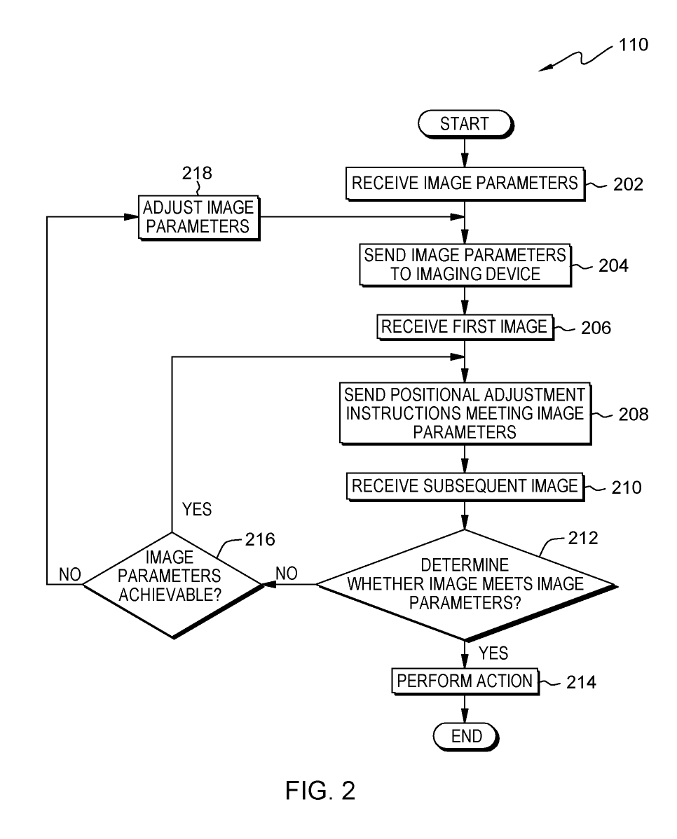

In an alternate example, if the image does not meet the image parameters, then image parameter-based positioning program 110 determines whether the image parameters are achievable. If image parameter-based positioning program 110 determines that the image parameters are not achievable, then image parameter-based positioning program 110 adjusts the image parameters to an achievable range and sends adjusted image parameters to unmanned imaging vehicle 104. Image parameter-based positioning program 110 is depicted and described in further detail with respect to FIG. 2.

In another embodiment, image parameter-based positioning program 110 resides on unmanned imaging vehicle 104 obviating the need for the wireless transfer of positional adjustment instructions. As such, unmanned imaging vehicle 104 directly executes the steps in the aforementioned examples using image parameter-based positioning program 110. In yet another embodiment, the aforementioned examples can be executed simultaneously on multiple unmanned imaging vehicles 104 with image parameter-based positioning program 110 residing on computer 108 or on unmanned imaging vehicle 104 and other devices not shown. For example, multiple unmanned imaging vehicles may receive image parameters that determine the position of the multiple unmanned imaging vehicles in the space around a subject with one or more unmanned imaging vehicles responsible for capturing video and the remaining unmanned imaging vehicles responsible for providing lighting. In yet another embodiment, one unmanned imaging vehicle 104 may include image parameter-based positioning program 110 and communicate positional adjustment instructions and image parameters to other unmanned imaging vehicles that do not include image parameter-based positioning program 110.

Database 112 is a repository for data used by image parameter-based positioning program 110. In the depicted embodiment, database 112 resides on computer 108. In another embodiment, database 112 may reside elsewhere within distributed data processing environment 100 provided image parameter-based positioning program 110 has access to database 112. Database 112 can be implemented with any type of storage device capable of storing data and configuration files that can be accessed and utilized by computer 108, such as a database server, a hard disk drive, or a flash memory. In some embodiments, database 112 may store any data that image parameter-based positioning program 110 uses to position unmanned imaging vehicle 104 in a three-dimensional space. For example, database 112 may store programs containing image parameters set by a user that the user may execute in order to achieve a photograph with particular image parameters. In various embodiments, database 112 may store data received by image parameter-based positioning program 110 and registration including configuration data of unmanned imaging vehicle 104. Examples of registration data include, but are not limited to, data identifying user preferences for image parameters and image parameters particular to one or more unmanned imaging vehicles. Examples of configuration data include, but are not limited to, policies identifying data that database 112 stores about particular image parameters, in association with a particular user.

FIG. 2 depicts operational steps for receiving image parameters, sending positional adjustment instructions meeting image parameters, and performing an action, on a computing device within the computing environment of FIG. 1, in accordance with an embodiment of the present invention. FIG. 2 is a flowchart depicting operations of an instance of image parameter-based positioning program 110 on computer 108 within distributed data processing environment 100. The operational steps of FIG. 2 begin when a user sends image parameters to image parameter-based positioning program 110. FIG. 2 as described herein is based on the operational steps of image parameter-based positioning program 110 located outside of unmanned imaging vehicle 104. However, alternative embodiments and configurations may execute the operational steps of image parameter-based positioning program 110.

Image parameter-based positioning program 110 receives image parameters (step 202). Image parameters correspond to the settings associated with a desired image. In some embodiments, image parameter-based positioning program 110 receives image parameters via network 102 from a user. In various embodiments, image parameter-based positioning program 110 receives specific parameters directly from a user. For example, image parameter-based positioning program 110 may reside on unmanned imaging vehicle 104. In another embodiment, image parameter-based positioning program 110 may receive ranges of acceptable values in different parameter categories from a user. For example, the user may input a range of acceptable shutter speeds, acceptable apertures, image boundaries, and light sensitivity settings (e.g., ISO). In an additional example, the user may also elect to activate or deactivate lens stabilization technology based on the ambient conditions. In another embodiment, image parameter-based positioning program 110 may determine the image parameters without user intervention by determining whether an image is acceptable given configured imaging policies stored on database 112 associated with image parameter-based positioning program 110. In one embodiment, the image boundaries may be marked using cues already present in the environment, such as the top of a building or people at the far ends of a group photo shoot, to allow image parameter-based positioning program 110 to determine the image boundaries. In another embodiment, the image boundaries may be marked using physical cues, digital cues, or both physical and digital cues placed by the user to enable image parameter-based positioning program 110 to determine the vertical and horizontal boundaries.

Image parameter-based positioning program 110 sends image parameters to an imaging device (step 204). In some embodiments, image parameter-based positioning program 110 may send image parameters to multiple imaging devices, such as unmanned imaging vehicle 104, via network 102. For example, image parameter-based positioning program 110 may send separate positioning instructions to an unmanned imaging vehicle containing a video camera and to unmanned imaging vehicles responsible for correctly lighting the captured image. In other embodiments, one or more imaging devices may include image parameter-based positioning program 110, and the image parameters may be directly inputted into the imaging device by a user. For example, a user may manually input image parameters via user interface 106 in each of the separate unmanned imaging vehicles, such as a specific camera tilt angle for the video capture and a different camera tilt angle settings based on lighting parameters depending on the characteristics of the subject's physical space, such as weather, ambient lighting, fluorescent lighting, shade, etc.

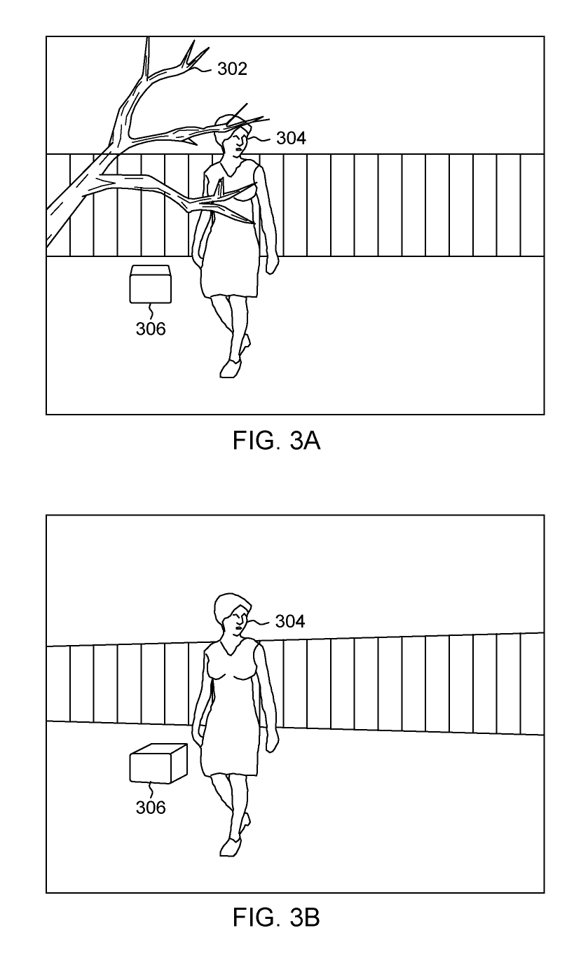

Image parameter-based positioning program 110 receives a first image (step 206). In some embodiments, the first image establishes the position of an imaging device in relation to an imaged subject. In the embodiments, image parameter-based positioning program 110 may use the first image to determine the positional adjustments needed to enable the imaging device to meet the image parameters. An exemplary embodiment is discussed in further detail with regards to FIG. 3A and FIG. 3B. In another embodiment, image parameter-based positioning program 110 uses the first image to determine the positional adjustments needed for multiple imaging devices with multiple image parameters. For example, image parameter-based positioning program 110 may use the first images from multiple unmanned imaging vehicles 104 and send out positional adjustment instructions to each of the multiple unmanned imaging vehicles 104 based on the particular role of each unmanned imaging vehicle 104, such as lighting the subject in a particular way, taking an image with a particular focal length, and taking an image at a particular angle. In yet another embodiment, image parameter-based positioning program 110 may receive a continuous stream of images enabling image parameter-based positioning program 110 to determine and send positional adjustment instructions to one or more unmanned imaging vehicles 104 with minimal latency. In yet another embodiment, image parameter-based positioning program 110 may receive one or more imaging devices' three dimensional positions from sensors incorporated into the one or more imaging devices to determine whether the position of the imaging device meets image parameters.

Image parameter-based positioning program 110 sends positional adjustment instructions meeting the image parameters (step 208). In an embodiment, image parameter-based positioning program 110 may send positional adjustment instructions meeting the image parameters to multiple imaging devices. For example, image parameter-based positioning program 110 may simultaneously send positional adjustment instructions to increase the height of the imaging device and downward angle of an image in response to an obstruction blocking the subject, such as a tree. Image parameter-based positioning program 110 may subsequently send positional adjustment instructions to imaging devices containing lighting elements to increase the lumen output to a level that compensates for the decreased ambient light resulting from the shadow of the tree. In yet another embodiment, image parameter-based positioning program 110 may independently adjust the image parameters to the setting as close to the user-specified settings given an unideal environment. For example, image parameter-based positioning program 110 may be programmed to send an instruction for an imaging device to take a photograph of a subject from a particular position despite the subject being partially obscured by foliage if no better alternative exists given the current conditions.

Image parameter-based positioning program 110 receives a subsequent image following a positional adjustment by unmanned imaging vehicle 104 (step 210). An exemplary embodiment is discussed in further detail with regards to FIG. 3A and FIG. 3B. In another embodiment, image parameter-based positioning program 110 may receive multiple subsequent images from various imaging devices. For example, image parameter-based positioning program 110 may receive subsequent images from an aerial drone responsible taking the photo, aerial drones responsible for lighting the subject, and ground-based drones responsible for ambient lighting. In yet another embodiment, image parameter-based positioning program 110 may not receive a subsequent image if the first image meets the image parameters.

Image parameter-based positioning program 110 determines whether the subsequent image meets the image parameters (decision block 212). In one embodiment, image parameter-based positioning program 110 compares the subsequent image to the image parameters to determine whether the subsequent image meets or falls in range of the image parameters set by a user while meeting minimum image quality settings, such as sharpness, noise levels, dynamic range, tone reproduction, contrast, color, low distortion, and exposure accuracy. For example, image parameter-based positioning program 110 may determine that the subsequent image meets the image parameters if the subsequent image achieves satisfactory contrast, sharpness, and noise levels set by the user while meeting or falling within an aperture, a focal length, and a shutter speed set by the user. In another embodiment, the minimum image quality settings are set as defaults in image parameter-based positioning program 110. In some embodiments, image parameter-based positioning program 110 determines that the first image meets the image parameters, image parameter-based positioning program 110 does not send positional adjustment instructions. For example, image parameter-based positioning program 110 does not determine whether the subsequent image meets the image parameters if the first image met the image parameters.

Following a determination that the image does not meet the image parameters (“no” branch, decision block 212), image parameter-based positioning program 110 determines whether image parameters are achievable (decision block 216). In one embodiment, an imaging vehicle (e.g., unmanned imaging vehicle 104) senses the surrounding area to determine whether there are any obstructions preventing the imaging vehicle from achieving a specific position or falling within the image parameters. For example, unmanned imaging vehicle 104 may use proximity sensors to detect physical obstructions in the environment, such as trees, building, branches, poles, people, clouds, etc. In another example, unmanned imaging vehicle 104 may use lighting sensors to determine whether the amount of ambient light is sufficient to meet light sensitivity image parameters. Image parameter-based positioning program 110 determines whether unmanned imaging vehicle 104 can achieve the image parameters given the sensed conditions.

If image parameter-based positioning program 110 determines that unmanned imaging vehicle 104 can achieve the image parameters (“yes” branch, decision block 216), then image parameter-based positioning program 110 sends positional adjustment instructions meeting the image parameters at step 208.

If image parameter-based positioning program 110 determines that the unmanned imaging vehicle 104 cannot achieve the image parameters (“no” branch, decision block 216), then image parameter-based positioning program 110 adjusts the image parameters to an achievable range (step 218). In an embodiment, image parameter-based positioning program 110 independently adjusts the image parameters depending on a range of image parameters set by a user. For example, a user may set the acceptable shutter speed between 1/20th and 1/200th of a second, the aperture between 1.8 and 3.5 for an image, a camera tilt of 15-25 degrees down, and the negative space around a framed subject as 20-30% of the overall image. In some embodiments, image parameter-based positioning program 110 may adjust the image parameters in unideal imaging situations so that the image parameters are within a range of values that most closely satisfy the image parameters given the imaging conditions. For example, image parameter-based positioning program 110 may automatically adjust the ISO value to increase light sensitivity if unmanned imaging vehicle 104 cannot take a photo meeting the original image parameters given the lack of ambient light. In another example, image parameter-based positioning program 110 may prompt a user for authorization to take a photo following the adjustment of image parameters. In yet another embodiment, image parameter-based positioning program 110 may prompt a user for authorization to adjust the image parameters after determining that image parameter-based positioning program cannot achieve the original image parameters. In another embodiment, image parameter-based positioning program 110 may neither adjust the image parameters nor perform an action if an adjustment cannot satisfy the image parameters. For example, image parameter-based positioning program 110 may determine that image parameters requiring a minimum amount of ambient light are unachievable given the lighting conditions and choose not to adjust the image parameters.

Following a determination that the image meets the image parameters (“yes” branch, decision block 212), image parameter-based positioning program 110 performs an action (step 214). In one embodiment, image parameter-based positioning program 110 performs an action associated with the image parameters, such as taking a photo with an imaging vehicle. In another embodiment, image parameter-based positioning program 110 performs an action associated with the image parameters, such as taking a video with an imaging device. In yet another embodiment, image parameter-based positioning program 110 causes the imaging device to perform an action, such as lighting the subject of the image for photographic purposes. In yet another embodiment, image parameter-based positioning program 110 performs an action associated with the image parameters, such a coordinated action among multiple unmanned imaging vehicles. For example, image parameter-based positioning program 110 may cause multiple unmanned imaging vehicles to coordinate lighting and video recording functions to provide the ideal shot of a subject. However, the performed action is not limited to embodiments herein and may include any action achieved using image parameters.

FIG. 3 depicts a scenario in which an image parameter-based positioning program repositions an unmanned imaging device to satisfy image parameters. FIG. 3A depicts a first image from an imaging device that does not satisfy the image parameters inputted by a user into image parameter-based positioning program 110. In the depicted embodiment, image parameter-based positioning program 110 frames image subject 304 in accordance with the image parameters, such as the focal length, the downward angle of the image, and the light sensitivity inputted by a user. Obstruction 302 partially obstructs image subject 304, and the image parameters cannot be met by image parameter-based positioning program 110. In another embodiment, the obstruction is not detected through the image but is detected through sensors associated with the imaging device instead. Object 306 provides a reference to the position of the imaging device in relation to image subject 304.

FIG. 3B depicts an example of a subsequent image of image subject 304 following image parameter adjustments made by image parameter-based positioning program 110. Obstruction 302 is no longer in the image, and the imaging device is in a different position relative to image subject 304 after making positional adjustments as discussed with respect to step 208 of FIG. 2. As a result, image subject 304 is now unobstructed which allows the imaging device to take a photo that meets the image parameters. In other embodiments, the imaging device may take a photo that does not meet the image parameters, but the imaging device takes a photo that most closely meets the original image parameters given unideal conditions. Object 306 provides a reference to the position of the imaging device in relation to image subject 304.

Computer 108 can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., image parameter-based positioning program 110 and database 112, are stored in persistent storage 408 for execution and/or access by one or more of the respective processor(s) 404 of computer 108 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 308.

Communications unit 410, in these examples, provides for communications with other data processing systems or devices, including resources of unmanned imaging vehicle 104. In these examples, communications unit 410 includes one or more network interface cards. Communications unit 410 may provide communications through the use of either or both physical and wireless communications links. Image parameter-based positioning program 110, database 112, and other programs and data used for implementation of the present invention, may be downloaded to persistent storage 408 of computer 108 through communications unit 410.

I/O interface(s) 412 allows for input and output of data with other devices that may be connected to computer 108. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., image parameter-based positioning program 110 and database 112 on computer 108, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for spatial positioning using image parameters, the method comprising:
identifying one or more image parameters for an image subject;
identifying a first image of the image subject taken by one or more imaging devices of an unmanned imaging vehicle;
responsive to determining that the first image does not meet the one or more image parameters for the image subject based, at least in part, on three-dimensional positioning data of an imaging device of the one or more imaging devices of the unmanned imaging vehicle and an angle of the imaging device to the image subject:
calculating a new position for the unmanned imaging vehicle based, at least in part, on a position of an obstruction that blocks, at least in part, the image subject, wherein the new position enables the one or more imaging devices of the unmanned imaging vehicle to capture a second image utilizing, at least in part, the identified one or more image parameters;
calculating one or more positional adjustment instructions based, at least in part, on the one or more image parameters for the image subject and the calculated new position for the unmanned imaging vehicle; and
sending the one or more positional adjustment instructions to the unmanned imaging vehicle.

2. The method of claim 1, wherein determining whether the first image meets the one or more image parameters further comprises, confirming that the first image falls within a range of camera tilt angles designated by a user.

3. The method of claim 1, further comprising:
determining whether the second image meets the one or more image parameters based, at least in part, on contrast in the second image; and
responsive to determining that the second image meets one or more image parameters, capturing a video of the image subject.

4. The method of claim 1, further comprising:
responsive to determining that the second image does not meet the one or more image parameters based, at least in part, on contrast in the second image, determining an amount of ambient light based, at least in part, on data received from one or more lighting sensors of the unmanned imaging vehicle; and
determining that the one or more image parameters are not achievable based at least in part, on the contrast in the second image and the amount of ambient light, and in response, adjusting an image parameter representing an adjusted ISO value based, at least in part, on the amount of ambient light.

5. The method of claim 4, further comprising:
sending the image parameter representing the adjusted ISO value to the one or more imaging devices of the unmanned imaging vehicle;
receiving a third image taken utilizing the adjusted ISO value; and
responsive to determining that the third image meets the one or more image parameters, capturing a video of the image subject.

6. (canceled)

7. (canceled)

8. A computer program product for spatial positioning using image parameters, the computer program product comprising:
one or more computer readable storage devices and program instructions stored on the one or more computer readable storage devices, the stored program instructions comprising:
program instructions to identify one or more image parameters for an image subject;
program instructions to identify a first image of the image subject taken by one or more imaging devices of an unmanned imaging vehicle;
responsive to determining that the first image does not meet the one or more image parameters for the image subject based, at least in part, on three-dimensional positioning data of an imaging device of the one or more imaging devices of the unmanned imaging vehicle and an angle of the imaging device to the image subject:
execute program instructions to calculate a new position for the unmanned imaging vehicle based, at least in part, on a position of an obstruction that blocks, at least in part, the image subject, wherein the new position enables the one or more imaging devices of the unmanned imaging vehicle to capture a second image utilizing, at least in part, the identified one or more image parameters;
execute program instructions to calculate one or more positional adjustment instructions based, at least in part, on the one or more image parameters for the image subject and the calculated new position for the unmanned imaging vehicle; and
sending the one or more positional adjustment instructions to the unmanned imaging vehicle.

9. The computer program product of claim 8, wherein determining whether the first image meets the one or more image parameters further comprises, program instructions to confirm that the first image falls within a range of camera tilt angles designated by a user.

10. The computer program product of claim 8, the stored program instructions further comprising:
program instructions to determine whether the second image meets the one or more image parameters based, at least in part, on contrast in the second image; and
responsive to determining that the second image meets one or more image parameters, execute program instructions to capture a video of the image subject.

11. The computer program product of claim 8, the stored program instructions further comprising:
program instructions to determine an amount of ambient light based, at least in part, on data received from one or more lighting sensors of the unmanned imaging vehicle in response to determining that the second image does not meet the one or more image parameters based, at least in part, on contrast in the second image; and
program instructions to adjust an image parameter representing an adjusted ISO value based, at least in part, on the amount of ambient light in response to determining that the one or more image parameters are not achievable based at least in part, on the contrast in the second image and the amount of ambient light.

12. The computer program product of claim 11, the stored program instructions further comprising:
program instructions to send the image parameter representing the adjusted ISO value to the one or more imaging devices of the unmanned imaging vehicle;
program instructions to identify a third image taken utilizing the adjusted ISO value; and
program instructions to capture a video of the image subject in response to determining that the third image meets the one or more image parameters.

13. (canceled)

14. (canceled)

15. A computer system for spatial positioning using image parameters,
the computer system comprising:
one or more computer processors;
one or more computer readable storage devices;
program instructions stored on the one or more computer readable storage devices for execution by at least one of the one or more computer processors, the stored program instructions comprising:
program instructions to identify one or more image parameters for an image subject;
program instructions to identify a first image of the image subject taken by one or more imaging devices of an unmanned imaging vehicle;
responsive to determining that the first image does not meet the one or more image parameters for the image subject based, at least in part, on three-dimensional positioning data of an imaging device of the one or more imaging devices of the unmanned imaging vehicle and an angle of the imaging device to the image subject:
execute program instructions to calculate a new position for the unmanned imaging vehicle based, at least in part, on a position of an obstruction that blocks, at least in part, the image subject, wherein the new position enables the one or more imaging devices of the unmanned imaging vehicle to capture a second image utilizing, at least in part, the identified one or more image parameters;
execute program instructions to calculate one or more positional adjustment instructions based, at least in part, on the one or more image parameters for the image subject and the calculated new position for the unmanned imaging vehicle; and
sending the one or more positional adjustment instructions to the unmanned imaging vehicle.

16. The computer system of claim 15, wherein determining whether the first image meets the one or more image parameters further comprises, program instructions to confirm that the first image falls within a range of camera tilt angles designated by a user.

17. The computer system of claim 15, the stored program instructions further comprising:
program instructions to determine whether the second image meets the one or more image parameters based, at least in part, on contrast in the second image; and
responsive to determining that the second image meets one or more image parameters, execute program instructions to capture a video of the image subject.

18. The computer system of claim 15, the stored program instructions further comprising:
program instructions to determine an amount of ambient light based, at least in part, on data received from one or more lighting sensors of the unmanned imaging vehicle in response to determining that the second image does not meet the one or more image parameters based, at least in part, on contrast in the second image; and
program instructions to adjust an image parameter representing an adjusted ISO value based, at least in part, on the amount of ambient light in response to determining that the one or more image parameters are not achievable based at least in part, on the contrast in the second image and the amount of ambient light.

19. The computer system of claim 18, the stored program instructions further comprising:
program instructions to send the image parameter representing the adjusted ISO value to the one or more imaging devices of the unmanned imaging vehicle;
program instructions to identify a third image taken utilizing the adjusted ISO value; and
program instructions to capture a video of the image subject in response to determining that the third image meets the one or more image parameters.

20. (canceled)
